(19) United States
(12) Patent Application Publication
(10) Pub. No.: US 2004/0188541 A1
(43) Pub. Date: Sep. 30, 2004

(54) Valve assembly having filter

(75) Inventor: Akira Maruyama, Toyohashi-city (JP)

Correspondence Address: POSZ & BETHARDS, PLC, 11250 ROGER BACON DRIVE, SUITE 10, RESTON, VA, 20190, US

(73) Assignee: ASMO CO., Ltd.

(21) Appl. No.: 10/811,870

(22) Filed: Mar. 30, 2004

(30) Foreign Application Priority Data
Mar. 31, 2003 (JP) 2003-95746

(51) Int. Cl. B05B 1/10

(52) U.S. Cl. 239/284.1; 239/570

(57) ABSTRACT

A valve arrangement is arranged in a fluid passage of a nozzle body of a washer nozzle. The valve arrangement permits forward flow of the washer fluid in a first direction from an inlet opening of the nozzle body toward discharge openings of the nozzle body and blocks backflow of the washer fluid in a second direction opposite from the first direction. A filter is arranged in the fluid passage of the nozzle body between the inlet opening and the valve arrangement to filter the washer fluid.

### CROSS REFERENCE TO RELATED APPLICATION

This application is based on and incorporates herein by reference Japanese Patent Application No. 2003-95746 filed on Mar. 31, 2003.

### BACKGROUND OF THE INVENTION

1. Field of the Invention

The present invention relates to a valve assembly having a filter, and more specifically to a washer nozzle of a washer system and a hose joint of a washer system, each of which includes the valve assembly.

2. Description of Related Art

One type of washer nozzle, which is provided in a vehicle body to wash a windshield (window glass), includes a filter. One such a washer nozzle is disclosed in, for example, Japanese Unexamined Patent Publication No. 2002-331918 (corresponding to U.S. Pat. No. 6,508,414).

This washer nozzle is connected to a connection pipe and includes a vertical fluid passage, a lateral fluid passage and a discharge opening. Washer fluid, which is supplied from the connection pipe to the vertical passage, is discharged from the discharge opening toward the windshield through the lateral fluid passage. The filter is provided in a connection between the vertical passage and the lateral passage. With this structure, foreign particles, such as debris and dirt particles, which are contained in the washer fluid, are blocked by the filter, and thereby clogging of the discharge opening with the foreign particles can be prevented.

Furthermore, the washer nozzle includes a check valve unit (including a compression spring, a resin plate and a rubber check valve). The check valve unit and the filter cooperate together to form a valve assembly. The check valve unit limits leakage of the washer fluid, which is contained in the vertical fluid passage and the lateral fluid passage, upon application of vibrations of the vehicle or application of acceleration of the vehicle.

However, the check valve unit is provided on an upstream side of the filter (i.e., on a washer fluid input side of the filter). Thus, the foreign particles, which are contained in the washer fluid and are blocked by the filter, may interfere with operational movement of the check valve unit or may deteriorate the sealing performance of the check valve unit to deteriorate the functions of the check valve unit.

Furthermore, the washer nozzle and the connection pipe are secured together by, for example, ultrasonic welding to achieve effective sealing performance of the connection between the washer nozzle and the connection pipe. Thus, once the washer nozzle and the connection pipe are assembled together, maintenance work or adjustment work of internal components (e.g., a valve body of the check valve and the filter) of the washer nozzle cannot be performed. Therefore, dispose of the entire washer nozzle is required.

Furthermore, the check valve unit includes the three components, i.e., the compression coil spring, the resin plate and the rubber check valve. Thus, the number of components and the number of assembling steps are relatively large, and therefore manufacturing costs are disadvantageously relatively high.

The above disadvantages may also exist in a case where the check valve unit and the filter are provided in a hose joint, which is inserted in a hose that supplies the washer fluid to the washer nozzle.

### SUMMARY OF THE INVENTION

The present invention addresses the above disadvantages. Thus, it is an objective of the present invention to provide a valve assembly, which includes a check valve and a filter and addresses the above disadvantages.

To achieve the objective of the present invention there is provided a valve assembly for a washer system. The valve assembly includes a housing, a check valve and a filter. The housing includes an inlet opening, at least one outlet opening and a fluid passage. Washer fluid is inputted into the housing through the inlet opening. The washer fluid is outputted from the housing through the at least one outlet opening. The fluid passage communicates between the inlet opening and the at least one outlet opening. The check valve is arranged in the fluid passage of the housing. The check valve permits forward flow of the washer fluid in a first direction from the inlet opening toward the at least one outlet opening and blocks backflow of the washer fluid in a second direction opposite from the first direction. The filter is arranged in the fluid passage of the housing between the inlet opening and the check valve to filter the washer fluid.

### BRIEF DESCRIPTION OF THE DRAWINGS

The invention, together with additional objectives, features and advantages thereof, will be best understood from the following description, the appended claims and the accompanying drawings in which:

FIG. 1 is a partially fragmented side view of a washer nozzle of a windshield washer system according to a first embodiment of the present invention, showing a closed state of a check valve of the washer nozzle;

FIG. 2 is a partially fragmented side view of the washer nozzle similar to FIG. 1, showing an open state of the check valve of the washer nozzle;

FIG. 3 is a plan view of a lower body of the washer nozzle of the first embodiment;

FIG. 4A is a plan view of a valve arrangement of the check valve of the washer nozzle according to the first embodiment;

FIG. 4B is a cross sectional view of the valve arrangement of the first embodiment;

FIG. 4C is a bottom view of the valve arrangement of the first embodiment;

FIG. 5 is a schematic view showing the windshield washer system of the first embodiment;

FIG. 6 is a partially fragmented side view showing a modification of the washer nozzle of the first embodiment;

FIG. 7 is a cross sectional view of a branched joint of a washer system according to a second embodiment of the present invention;

FIG. 8 is a side view of the branched joint of the second embodiment; and

FIG. 9 is a partially fragmented side view showing a modification of the branched of the second embodiment.

### DETAILED DESCRIPTION OF THE INVENTION

(First Embodiment)

A windshield washer system 12 according to a first embodiment of the present invention includes a washer tank 14. The washer tank 14 is installed in, for example, an engine room (not shown) of a vehicle and is filled with washer fluid 16. A washer pump 18 is installed in the washer tank 14, and one end of an inlet-side hose 20 is connected to the washer pump 18.

The other end of the inlet-side hose 20 is connected to a branched joint 22. The branched joint 22 includes an inlet-side body 24 and an outlet-side body 26. One end of the inlet-side body 24 is engaged with, i.e., is connected to the inlet-side hose 20. The other end of the inlet-side body 24 is engaged with, i.e., is connected to the outlet-side body 26. An end of each of a plurality (two in the present embodiment) of outlet-side hoses 28 is connected to the outlet-side body 26, and a corresponding washer nozzle 10 is connected to the other end of each outlet-side hose 28. When the washer pump 18 is driven, the washer fluid 16 is supplied (pumped) from the washer tank 14 to each washer nozzle 10 through the inlet-side hose 20, the branched joint 22 (the inlet-side body 24 and the outlet-side body 26) and the corresponding outlet-side hose 28.

Each washer nozzle 10 is arranged to a portion (e.g., a bonnet) of a vehicle body, which is adjacent to an undepicted windshield (window glass).

Each washer nozzle 10 includes a nozzle body (housing of a valve assembly) 30. The nozzle body 30 includes a generally cylindrical lower body 32 (adapter) at a lower side of the nozzle body 30. The lower body 32 serves as a first body part of the present invention. A cylindrical inlet passage 34 extends in the lower body 32, and a circular inlet opening 36 is formed in a lower end of the inlet passage 34. The other end of the corresponding outlet-side hose 28 is connected to a lower part of the lower body 32, and an interior of the outlet-side hose 28 is communicated with the inlet opening 36. Thus, when the washer fluid 16 is pumped to the washer nozzle 10, the washer fluid 16 is supplied (pumped) from the inlet opening 36 into the inlet passage 34.

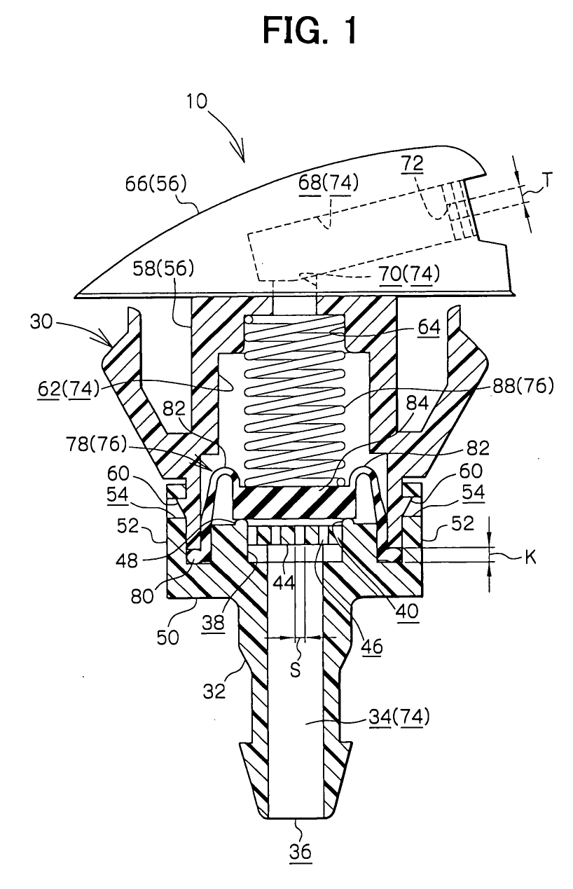

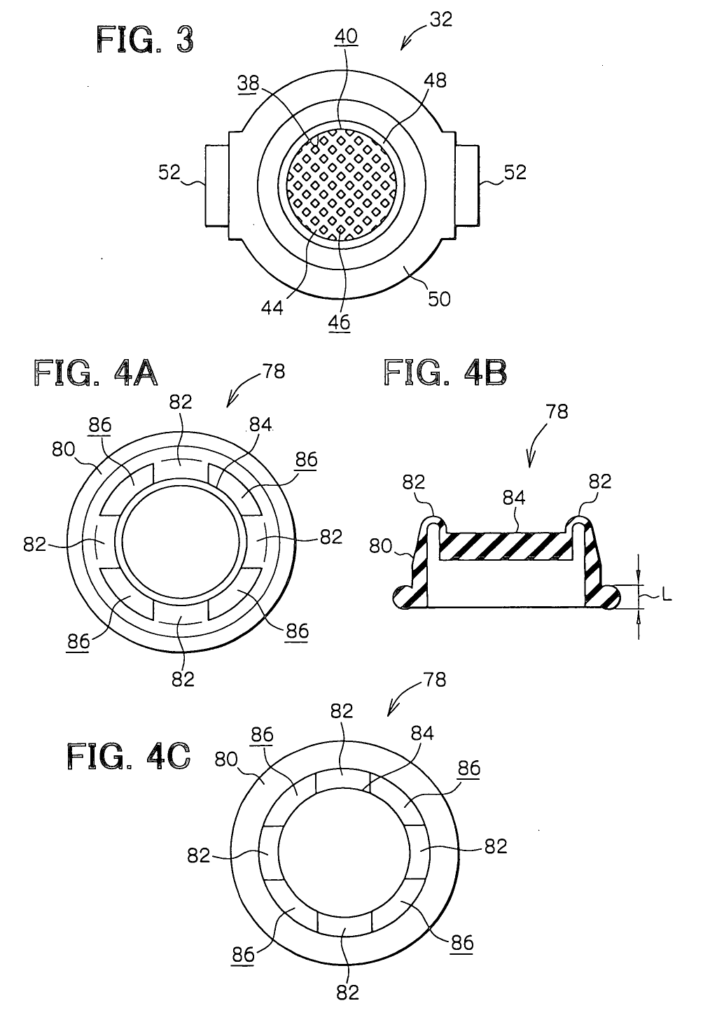

An inner diameter of an upper part of the inlet passage 34 is enlarged to form a cylindrical fitting hole 38. An upper end of the fitting hole 38 forms a circular communication opening 40. In the fitting hole 38, a disk-shaped filter 44 is formed integrally with the lower body 32. As shown in FIG. 3, a plurality of quadrangular filter holes 46 extends through the filter 44 to form a lattice-like structure. With this structure, foreign particles, such as debris and dirt particles, which are contained in the washer fluid 16 supplied into the inlet passage 34, are blocked and are removed by the filter 44. A maximum width S of the filter holes 46 is smaller than an inner diameter T of a discharge opening (outlet opening) 72 (FIG. 1).

An annular valve seat 48 is formed along an entire perimeter of the fitting hole 38 (the communication opening 40) at an upper surface of the lower body 32. The valve seat 48 has a semicircular cross section and protrudes upwardly from the upper surface of the lower body 32 in such a manner that the curved surface of the valve seat 48 is oriented upwardly. With this structure, the valve seat 48 protrudes upwardly beyond the filter 44.

An annular clamp plate 50 is formed in the upper part of the lower body 32. A predetermined number (two in the present embodiment) of rectangular engaging plates 52 is formed in an outer peripheral surface of the clamp plate 50. The engaging plates 52 are arranged at equal intervals in a circumferential direction of the clamp plate 50 and protrude upwardly. The engaging plates 52 have resiliency. A rectangular engaging hole (engaging portion) 54 radially extends through an upper part of each engaging plate 52.

The nozzle body 30 further includes an upper body (nozzle main body) 56 in the upper part of the nozzle body 30. The upper body 56 serves as a second body part of the present invention. A portion of the upper body 56 other than an upper part of the upper body 56 is formed as a generally cylindrical connecting portion 58. A predetermined number (two in the present embodiment) of triangular engaging projections (engaging portions) 60 projects radially outwardly from an outer peripheral surface of a lower part of the connecting portion 58 to correspond with the engaging holes 54 of the lower body 32. The engaging projections 60 are arranged at equal intervals in a circumferential direction of the connecting portion 58. When the engaging plates 52 of the lower body 32 are resiliently deformed, and the engaging projections 60 are inserted into the corresponding engaging holes 54, the engaging holes 54 are engaged with, i.e., are snap-fitted to the corresponding engaging projections 60. Thus, the upper body 56 (the connecting portion 58) is fitted to the lower body 32 (the engaging plates 52). At this time, a space K (FIG. 1) between a lower surface of the connecting portion 58 and an upper surface of the clamp plate 50 of the lower body 32 is set to be smaller than a maximum vertical size L (FIG. 4B) of an O-ring section of an anchoring portion 80, which will be described below.

Furthermore, an upper surface of each engaging projection 60 is a flat lateral surface and is engaged with an upper surface of the corresponding engaging hole 54. Thus, removal of the engaging projections 60 from the corresponding engaging holes 54 is limited to limit removal of the connecting portion 58 (the upper body 56) from the engaging plates 52 (the lower body 32). Furthermore, a lower surface of each engaging projection 60 is a tilted surface, and resilient deformation of each engaging plate 52 is induced by the lower surface of the corresponding engaging projection 60.

A generally cylindrical communication passage 62 is formed in the connecting portion 58. An upper part of the communication passage 62 has a reduced inner diameter to form a cylindrical retaining hole 64.

A discharge portion 66, which generally has a half cone shape, is formed in the upper part of the upper body 56. The discharge portion 66 is formed integrally with the connecting portion 58. A predetermined number (one or two in the present embodiment) of cylindrical discharge passages 68 is formed in the discharge portion 66. One end of each discharge passage 68 is communicated with the retaining hole 64 of the connecting portion 58 through a cylindrical guide passage 70. The guide passage 70 extends from the connecting portion 58 to the discharge portion 66 to form an upper end portion of the communication passage 62. An inner diameter of the guide passage 70 is set to be smaller than an inner diameter of the retaining hole 64.

A discharge opening 72 is formed in the other end of each discharge passage 68 and has an inner diameter smaller than an inner diameter of the discharge passage 68. The discharge opening 72 is opposed to the windshield. The inlet passage 34 (including the fitting hole 38), the communication passage 62 (including the retaining hole 64), the guide passage 70 and the discharge passage(s) 68 form a fluid passage 74, which communicates between the inlet opening 36 and the discharge opening(s) 72.

A check valve unit 76 is provided in the fluid passage 74 of the nozzle body 30 (the communication passage 62 of the upper body 56). The check valve unit 76 and the filter 44 form a part of the valve assembly of the present invention. As shown in FIGS. 4A-4C, the check valve unit 76 includes a valve arrangement (a check valve) 78. The valve arrangement 78 is made of a resilient material (rubber in the present embodiment). The valve arrangement 78 includes a generally cylindrical (generally annular) anchoring portion 80. The anchoring portion 80 has a generally L-shaped cross section. The cylindrical portion of the anchoring portion 80 is fitted to an outer peripheral surface of the upper part of the lower body 32 (upper part of the clamp plate 50). The cylindrical portion of the anchoring portion 80 is radially securely clamped between the lower part of the connecting portion 58 of the upper body 56 and the upper part of the lower body 32. The O-ring section of the lower part of the anchoring portion 80 is vertically securely clamped between the lower surface of the connecting portion 58 of the upper body 56 and the upper surface of the clamp plate 50 of the lower body 32. Thus, the valve arrangement 78 is secured through the anchoring portion 80. The anchoring portion 80 is radially and vertically clamped by the lower body 32 and the upper body 56 to seal therebetween. More specifically, the O-ring section of the lower part of the anchoring portion 80 is resiliently deformed by the lower surface of the connecting portion 58 and the upper surface of the clamp plate 50 and is tightly clamped by the lower surface of the connecting portion 58 and the upper surface of the clamp plate 50.

A predetermined number (four in the present embodiment) of thin connectors (valve connectors) 82 is formed integrally in the anchoring portion 80. Each connector 82 has an inverted U-shaped cross section. The connectors 82 are arranged at generally equal intervals in a circumferential direction of the anchoring portion 80 and radially inwardly projects from a top end of the anchoring portion 80.

The connectors 82 integrally support a circular disk-shaped valve body 84. The valve body 84 is engaged with the valve seat 48 formed in the perimeter of the communication opening 40 (of the fitting hole 38) to close the communication opening 40 (the fluid passage 74). The valve body 84 is urged by the anchoring portion 80 and the connectors 82 toward the communication opening 40 (toward the inlet opening 36). Furthermore, the valve arrangement 78 further includes flow passages (slits) 86. Each flow passage 86 extends through the valve arrangement 78. Also, each flow passage 86 is circumferentially defined between corresponding two of the connectors 82 and is radially defined between the anchoring portion 80 and the valve body 84.

The check valve unit 76 further includes a compression coil spring 88. The compression coil spring 88 is retained in the retaining hole 64 in such a manner that an upper end of the compression coil spring 88 is engaged with an upper surface of the retaining hole 64. A lower end of the compression coil spring 88 is engaged with the valve body 84 of the valve arrangement 78. Thus, the compression coil spring 88 urges the valve body 84 toward the communication opening 40 (toward the inlet opening 36).

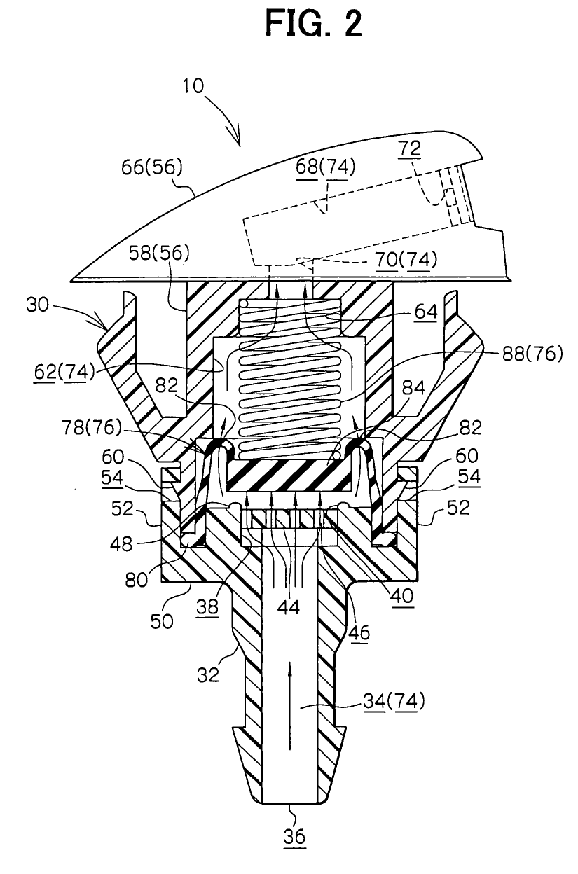

When the washer fluid 16 is supplied (pumped) from the inlet opening 36 into the inlet passage 34, the valve body 84 is moved (pushed) away from the communication opening 40 by fluid pressure of the washer fluid 16, as shown in FIG. 2. Thus, the washer fluid 16 is discharged from the discharge opening 72 to the windshield through the communication passage 62 (including the flow passages 86 of the valve arrangement 78 and the retaining hole 64), the guide passage 70 and the corresponding discharge passage 68. The inlet passage 34 and the fitting hole 38 form a first part of the fluid passage 74, which is provided in the lower body 32. The communication passage 62, the guide passage 70 and the discharge passage 68 form a second part of the fluid passage 74, which is provided in the upper body 56.

Next, operation of the washer system 12 of the present embodiment will be described.

In the washer system 12, when the washer pump 18 is driven, the washer fluid 16 is supplied (pumped) from the washer tank 14 to each washer nozzle 10 through the inlet-side hose 20, the branched joint 22 (the inlet-side body 24 and the outlet-side body 26) and the corresponding outlet-side hose 28. Furthermore, in the washer nozzle 10, the washer fluid 16 is supplied to the inlet opening 36 of the lower body 32 and is then supplied (pumped) to the communication opening 40 through the inlet passage 34 (including the fitting hole 38). When the fluid pressure of the washer fluid 16 becomes greater than a closing force (the sum of the urging force of the anchoring portion 80 and the connectors 82 of the valve arrangement 78 and the urging force of the compression coil spring 88), which is applied to the valve body 84 of the valve arrangement 78 for closing the communication opening 40, the connectors 82 and the anchoring portion 80 are stretched, and compression coil spring 88 is compressed. Thus, the valve body 84 is moved (lifted) away from the communication opening 40 by the fluid pressure of the washer fluid 16. Thus, the washer fluid 16 is supplied (pumped) from the communication opening 40 to the communication passage 62 of the upper body 56 and is discharged from the corresponding discharge opening 72 through the communication passage 62 (including the flow passages 86 of the valve arrangement 78 and the retaining hole 64), the guide passage 70 and the corresponding discharge passage 68. In this way, the washer fluid 16 is discharged to the windshield to wash the windshield.

When the washer pump 18 is stopped, i.e., is in a non-operating state, the washer fluid 16 is not supplied to the inlet opening 36, so that the valve body 84 closes the communication opening 40. Thus, the flow of the washer fluid 16 from the communication opening 40 (fitting hole 38) to the communication passage 62 and the flow of the washer fluid 16 from the communication passage 62 to the communication opening 40 (the fitting hole 38) are limited. Therefore, in the non-operating state of the washer pump 18, even when the acceleration is applied to the washer fluid 16, which is contained in the inlet-side hose 20, the branched joint 22 and the outlet-side hoses 28, due to the vibrations and turning movement of the vehicle, the washer fluid 16 contained in, for example, the discharge passage 68 does not leak from the corresponding discharge opening 72. Furthermore, the washer fluid 16 can be kept filled in the inlet-side hose 20, the outlet-side hoses 28 and the washer nozzles 10. More specifically, the valve body 84 closes the communication opening 40, so that flow of air from the discharge opening 72 into the washer nozzles 10, into the outlet-side hoses 28, into the branched joint 22 and into the inlet-side hose 20 can be limited. As a result, when the washer pump 18 is driven to pump the washer fluid 16, the valve body 84 of each washer nozzle 10 is immediately lifted by the washer fluid 16. Therefore, the time required to initiate the discharge of washer fluid 16 from the discharge opening 72 of the washer nozzle 10 becomes short, so that discharge response (the time required to discharge the washer fluid 16 upon receiving a discharge command for discharging the washer fluid 16) can be improved.

Furthermore, the filter 44, which is provided in the fitting hole 38 of the lower body 32, limits passing of the foreign particles contained in the washer fluid 16. Thus, clogging of the discharge opening 72 is advantageously limited.

Also as described above, the check valve unit 76 is provided in the communication passage 62 of the upper body 56, and the filter 44 is provided in the fitting hole 38 of the lower body 32. Thus, the filter 44 is located on the inlet opening 36 side of the check valve unit 76 (valve arrangement 78) provided in the fluid passage 74, i.e., is located on an upstream side of the check valve unit 76 (valve arrangement 78). With this structure, the foreign particles contained in the washer fluid 16 are blocked by the filter 44 and thus do not interfere the movement of the check valve unit 76 or do not deteriorate sealing performance of the check valve unit 76, thereby advantageously limiting deterioration or malfunction of the check valve unit 76.

The nozzle body 30 includes the lower body 32, which includes the inlet opening 36, and the upper body 56, which includes the discharge opening 72 and is assembled with the lower body 32. With this structure, the check valve unit 76 and the filter 44 can be easily provided in the nozzle body 30.

Furthermore, the lower body 32 and the upper body 56 are assembled together by the engagement of the engaging projections 60 to the engaging holes 54. At the time of this engagement, the anchoring portion 80 of the valve arrangement 78 is radially securely clamped between the upper part of the lower body 32 and the lower part of the connecting portion 58 of the upper body 56 in the cylindrical portion, and the O-ring section of the anchoring portion 80 is vertically securely clamped between the upper surface of the clamp plate 50 of the lower body 32 and the lower surface of the connecting portion 58 and is radially and vertically clamped by the lower body 32 and the upper body 56 to seal therebetween. Thus, the valve arrangement 78 can be secured through the anchoring portion 80 without requiring joining of the lower body 32 with the upper body 56 by, for example, ultrasonic welding. Furthermore, sealing of the nozzle body 30 can be achieved by the anchoring portion 80. In this way, even after assembly of the lower body 32 and the upper body 56, the lower body 32 and the upper body 56 can be separated from one another by disengaging the engaging projections 60 from the engaging holes 54. Thus, maintenance work or adjustment work of the interior of the nozzle body 30 (e.g., the check valve unit 76 or the filter 44) can be performed. Furthermore, this structure allows replacement of a defective component of the washer nozzle 10 with an appropriate replacement component. Therefore, it is not required to replace the entire washer nozzle 10 with a new one, and it is only required to replace the defective component of the washer nozzle 10 with the appropriate replacement component, allowing recycling of the other components of the washer nozzle 10.

Furthermore, as discussed above, the anchoring portion 80 of the valve arrangement 78 seals the connection between the lower body 32 and the upper body 56, so that it is not required to provide a separate sealing component, which seals the connection between the lower body 32 and the upper body 56. The check valve unit 76 only includes the valve arrangement 78 and the compression coil spring 88. Thus, the number of components and the number of assembling steps can be reduced in comparison to the previously proposed one discussed above to minimize the manufacturing costs.

The compression coil spring 88 is arranged in the communication passage 62 of the upper body 56 and urges the valve body 84 of the valve arrangement 78 toward the communication opening 40 (toward the inlet opening 36). Thus, the valve body 84 can quickly close the communication opening 40 (the fluid passage 74) to improve closing response for closing the communication opening 40 by the valve body 84. Furthermore, the closed state of the communication opening 40 can be effectively maintained by the valve body 84 through use of the urging force of the compression coil spring 88.

Furthermore, the valve body 84 contacts the valve seat 48, which is provided around the communication opening 40. In this embodiment, the valve seat 48 projects toward the valve body 84 beyond the filter 44, so that the valve body 84 does not have surface contact with the filter 44 but has line contact with the valve seat 48. Thus, the contact pressure of the valve body 84 against to the valve seat 48 is advantageously increased, so that the valve body 84 can effectively close the communication opening 40.

Furthermore, the valve body 84 contacts the valve seat 48, which is provided around the communication opening 40, while the anchoring portion 80 and the connectors 82 of the valve arrangement 78 are stretched. Thus, the valve body 84 can be engaged with the valve seat 48 while the valve body 84 is pressed by the contracting force (urging force) of the anchoring portion 80 and the connectors 82. Furthermore, at the time of engaging the valve body 84 with the valve seat 48, the valve body 84 conforms to a shape of an upper end of the valve seat 48 (an outer peripheral shape of the communication opening 40) due to the elasticity of the valve body 84. In this way, the communication opening 40 can be effectively closed, and flow of the washer fluid 16 from the communication opening 40 into the communication passage 62 and return flow of the washer fluid 16 from the communication passage 62 into the communication opening 40 can be effectively limited.

Furthermore, when the upper body 56 and the lower body 32 are assembled together, the engaging projections 60 of the upper body 56 are engaged with the engaging holes 54 of the lower body 32, and the resiliently deformed anchoring portion 80 (O-ring section) of the valve arrangement 78 is tightly clamped between the upper surface of the clamp plate 50 and the lower surface of the connecting portion 58. Thus, restoring force of the resiliently deformed anchoring portion 80 can maintain the state of the engagement between the engaging projections 60 and the engaging holes 54 (i.e., the engagement between the lateral surface of the engaging projection 60 and the upper surface of the engaging hole 54) without generating rattling vibrational noise. In this way, the engagement between the upper body 56 and the lower body 32 can be maintained without generating the rattling vibrational noise, so that inappropriate assembly of the upper body 56 with the lower body 32 can be avoided. Furthermore, the engagement between the engaging projections 60 and the engaging holes 54 can maintain the tight clamping of the resiliently deformed anchoring portion 80. Thus, the secured state of the valve arrangement 78 is maintained, and the sealing of the nozzle body 30 is maintained.

In the present embodiment, the check valve unit 76 includes the valve arrangement 78 and the compression coil spring 88. However, the compression coil spring 88 can be eliminated to construct the check valve unit only with the valve arrangement 78 if the required closing force for closing the communication opening 40 by the valve body 84 can be achieved only by the urging force of the anchoring portion 80 and the connectors 82 of the valve arrangement 78, i.e., if the flow of the washer fluid 16 from the communication opening 40 into the communication passage 62 and the return flow of the washer fluid 16 from the communication passage 62 into the communication opening 40 can be effectively limited in the non-operating state of the washer pump 18. In such a case, the check valve unit only includes the valve arrangement. Thus, the number of components and the number of assembling steps can be further reduced, and thereby the manufacturing costs can be further reduced.

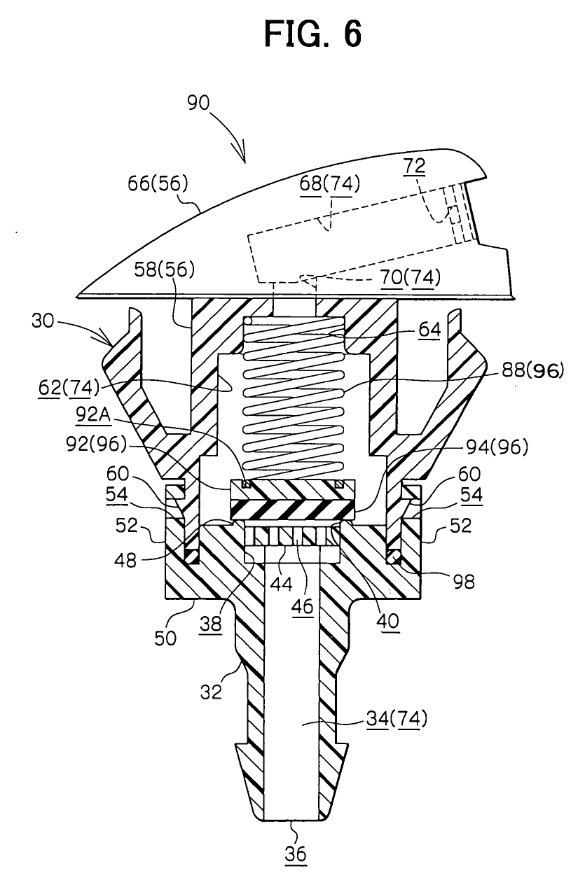

Furthermore, a check valve unit 96, which includes a compression coil spring 88, a spring holder 92 and a packing 94, can be used in place of the check valve unit 76 of the above embodiment, as in a case of washer nozzle 90 shown in FIG. 6. In this case, the spring holder 92 is made of a resin material and is formed into a circular disk shape. An annular engaging groove 92A, which has a rectangular cross section, is formed in an upper surface of the spring holder 92. A lower end of the compression coil spring 88 is fitted into the fitting groove 92A. In this way, the spring holder 92 is retained by the compression coil spring 88. The packing 94 is formed into a circular disk shape and is made of, for example, a rubber material to have resiliency. An upper surface of the packing 94 is secured to a lower surface of the spring holder 92. Due to urging force of the compression coil spring 88, a lower surface of the packing 94 is engaged with the valve seat 48 to close the communication opening 40. Furthermore, an annular resilient O-ring 98 is resiliently deformed and is tightly clamped between the upper surface of the clamp plate 50 and the lower surface of the connecting portion 58, so that the nozzle body 30 is sealed.

(Second Embodiment)

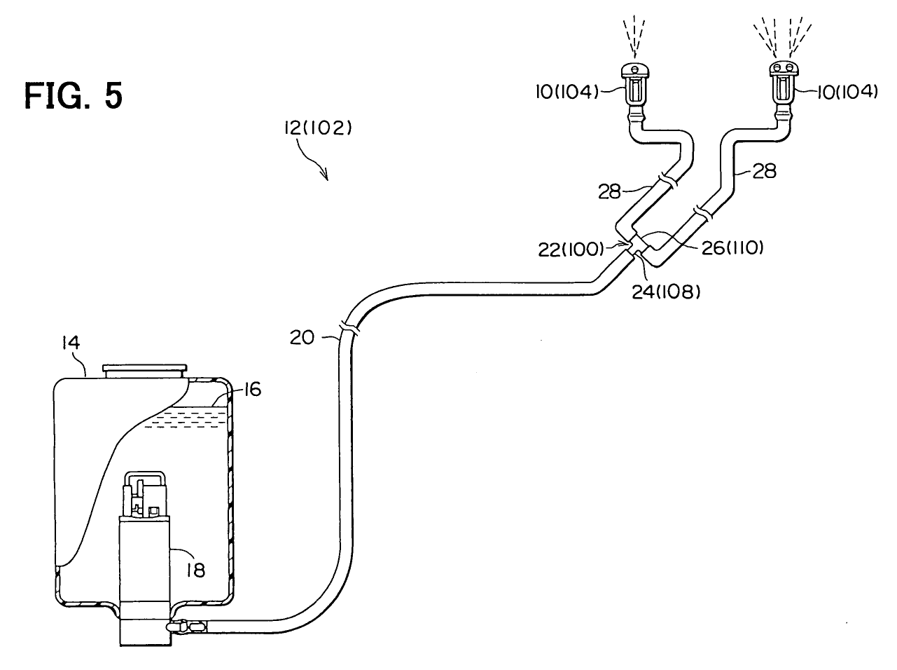

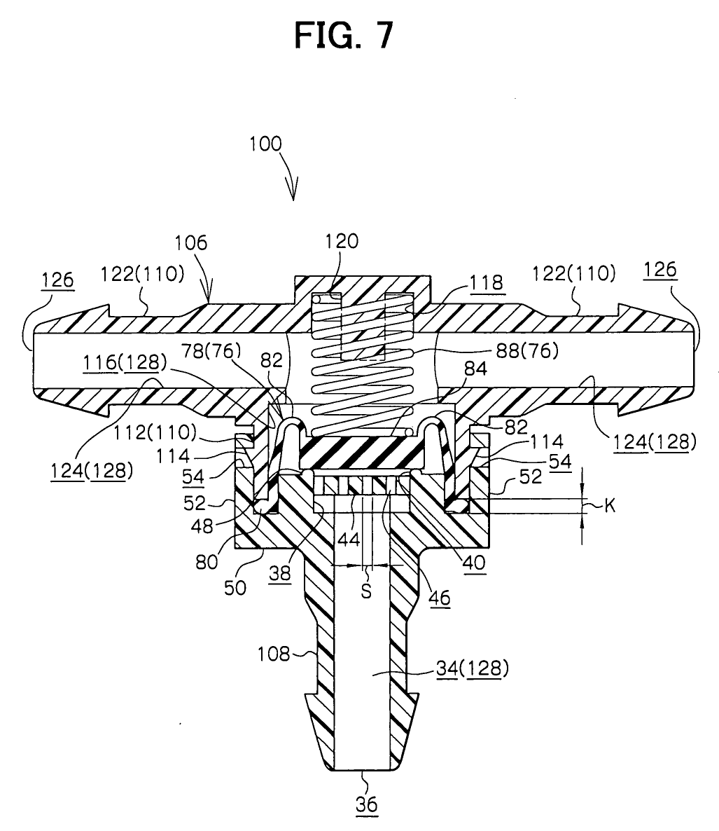

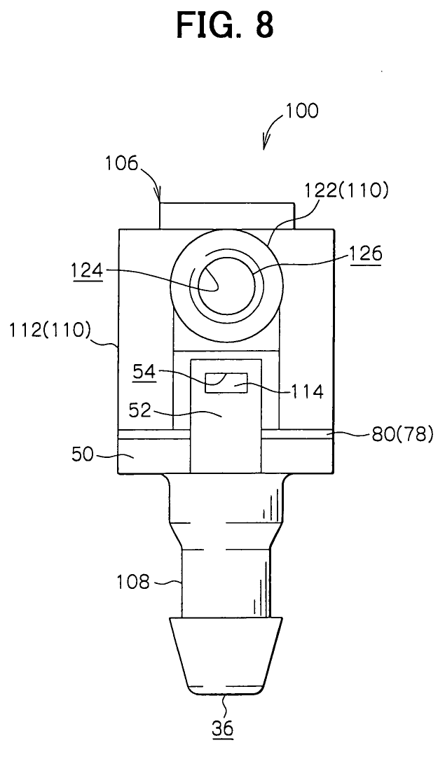

With reference to FIGS. 7 and 8, a branched joint 100 of a second embodiment is used in place of the branched joint 22 of the windshield washer system 12 of FIG. 5 and forms part of a windshield washer system 102 (FIG. 5). In the windshield washer system 102, a washer nozzle 104 (FIG. 5) is used in place of the washer nozzle 10. Unlike the washer nozzle 10, the washer nozzle 104 does not have the check valve unit 76 and the filter 44. Furthermore, in the windshield washer system 102, it is preferred that the branched joint 100 is placed in a closest possible position relative to the washer nozzle 104 to achieve the effective discharge response.

The branched joint 100 includes a joint body (housing of a valve assembly) 106. The joint body 106 includes a lower inlet-side body 108 (adapter) and an upper outlet-side body 110. The inlet-side body 108 serves as a first body part of the present invention, and the outlet-side body 110 serves as a second body part of the present invention.

The inlet-side body 108 is formed into a generally cylindrical shape and has a structure similar to that of the lower body 32 of the washer nozzle 10. The inlet-side body 108 includes the inlet passage 34 (including the inlet opening 36, the fitting hole 38 and the communication opening 40), the filter 44 (including the filter holes 46), the valve seat 48, the clamp plate 50 and the predetermined number of engaging plates 52 (including the engaging holes 54).

The other end of the inlet-side hose 20 is connected to the lower part of the inlet-side body 108, and an interior of the inlet-side hose 20 is communicated with the inlet opening 36). Thus, when the washer pump 18 is driven, the washer fluid 16 is supplied (pumped) from the washer tank 14 to the inlet-side body 108 through the inlet-side hose 20. Thus, the washer fluid 16 is supplied (pumped) from the inlet opening 36 into the inlet passage 34. Furthermore, the foreign particles, which are contained in the washer fluid 16 that is supplied into the inlet passage 34, are blocked by the filter 44. Thus, the foreign particles are removed from the washer fluid 16, which has passed the filter 44 (the filter holes 46).

The outlet-side body 110 includes a generally cylindrical connecting portion 112. A predetermined number (two in the present embodiment) of triangular engaging projections (engaging portions) 114 projects radially outwardly from an outer peripheral surface of a lower part of the connecting portion 112 to correspond with the engaging holes 54 of the inlet-side body 108. The engaging projections 114 are arranged at equal intervals in a circumferential direction of the connecting portion 112. When the engaging plates 52 of the inlet-side body 108 are resiliently deformed, and the engaging projections 114 are inserted into the corresponding engaging holes 54, the engaging holes 54 are engaged with, i.e., are snap-fitted to the corresponding engaging projections 114. Thus, the outlet-side body 110 (the connecting portion 112) is fitted to the inlet-side body 108 (the engaging plates 52). At this time, a space K (FIG. 7) between a lower surface of the connecting portion 112 and an upper surface of the clamp plate 50 of the inlet-side body 108 is set to be smaller than the maximum vertical size L (FIG. 4B) of the O-ring section of the anchoring portion 80, which will be described below.

Furthermore, an upper surface of each engaging projection 114 is a flat lateral surface and is engaged with an upper surface of the corresponding engaging hole 54. Thus, removal of the engaging projections 114 from the corresponding engaging holes 54 is limited to limit removal of the connecting portion 112 (the outlet-side body 110) from the engaging plates 52 (the inlet-side body 108). Furthermore, a lower surface of each engaging projection 114 is a tilted surface, and resilient deformation of each engaging plate 52 is induced by the lower surface of the corresponding engaging projection 114.

An upper surface of the connecting portion 112 is closed, and a generally cylindrical communication passage 116 is formed in the connecting portion 112. A cylindrical retaining hole 118 is formed in an upper surface of the communication passage 116. The retaining hole 118 extends upwardly from the upper surface of the communication passage 116. A retaining protrusion 120 is formed in a center of the retaining hole 118. The retaining protrusion 120 protrudes downwardly from the upper surface of the communication passage 116. Furthermore, the retaining hole 118 and the retaining protrusion 120 is opposed to the communication opening 40 (the fitting hole 38) of the inlet-side body 108.

A plurality (two in the present embodiment) of generally cylindrical tubular outlet portions 122 is formed in a top of an outer peripheral surface of the connecting portion 112, so that the outlet-side body 110 is branched into the plurality of portions. The outlet portions 122 are arranged at equal intervals in a circumferential direction of the connecting portion 112.

An outlet passage 124 is formed in each outlet portion 122. One end of each outlet passage 124 is communicated with the communication passage 116, and the other end of each outlet passage 124 is communicated with a corresponding circular outlet opening 126 formed in a distal end of the corresponding outlet portion 122. The inlet passage 34 (including the fitting hole 38), the communication passage 116 (including the retaining hole 118) and each outlet passage 124 form a fluid passage 128. The fluid passage 128 communicates between the inlet opening 36 and each outlet opening 126. The inlet passage 34 and the fitting hole 38 form a first part of the fluid passage 128, which is provided in the inlet-side body 108. The communication passage 116 and the outlet passages 124 form a second part of the fluid passage 128, which is provided in the outlet-side body 110.

One end of each outlet-side hose 28 is connected to a distal end of a corresponding one of the outlet portions 122, and each outlet opening 126 is communicated with the interior of the corresponding outlet-side hose 28.

The check valve unit 76, which is similar to the one discussed with reference to the first embodiment (FIGS. 4A-4C), is provided in the fluid passage 128 of the joint body 106 (the communication passage 116 of the outlet-side body 110).

The cylindrical portion of the anchoring portion 80 of the valve arrangement 78 of the check valve unit 76 is fitted to an outer periphery of the upper part (above the clamp plate 50) of the inlet-side body 108. The cylindrical portion of the anchoring portion 80 is radially securely clamped between the lower part of the connecting portion 112 of the outlet-side body 110 and the upper part of the inlet-side body 108. The O-ring section of the lower part of the anchoring portion 80 is vertically securely clamped between the lower surface of the connecting portion 112 of the outlet-side body 110 and the upper surface of the clamp plate 50 of the inlet-side body 108. Thus, the valve arrangement 78 is secured through the anchoring portion 80. The anchoring portion 80 is radially and vertically clamped by the outlet-side body 110 and the inlet-side body 108 to seal therebetween. More specifically, the O-ring section of the lower part of the anchoring portion 80 is resiliently deformed by the lower surface of the connecting portion 112 and the upper surface of the clamp plate 50 and is tightly clamped by the lower surface of the connecting portion 112 and the upper surface of the clamp plate 50.

The valve body 84 of the valve arrangement 78 is engaged with the valve seat 48 located in the perimeter of the communication opening 40 (fitting hole 38) to close the communication opening 40 (the fluid passage 128). Furthermore, the valve body 84 is pressed (urged) toward the communication opening 40 by the anchoring portion 80 and the connectors 82.

The compression coil spring 88 of the check valve unit 76 is held in the retaining hole 118 in such a manner that an upper end of the compression coil spring 88 of the check valve unit 76 is engaged with the upper surface of the retaining hole 118, and the retaining protrusion 120 is received in the interior of the compression coil spring 88. A lower end of the compression coil spring 88 is engaged with the valve body 84 of the valve arrangement 78 to press (urge) the valve body 84 toward the communication opening 40 side (toward the inlet opening 36).

When the washer fluid 16 is supplied (pumped) from the inlet opening 36 into the inlet passage 34, the valve body 84 is moved (pushed) away from the communication opening 40 by the fluid pressure of the washer fluid 16. Thus, the washer fluid 16 is discharged from each outlet opening 126 through the communication passage 116 (including the flow passages 86 of the valve arrangement 78 and the retaining hole 118) and the corresponding outlet passage 124. In this way, the washer fluid 16 is supplied (pumped) to each washer nozzle 104 through the corresponding outlet-side hose 28 and is discharged from the corresponding washer nozzle 104 toward the windshield.

Next, the operation of the washer system 102 of the second embodiment will be described.

In the washer system 102, when the washer pump 18 is driven, the washer fluid 16 is supplied (pumped) from the washer tank 14 to the branched joint 100 through the input-side hose 20. In the branched joint 100, the washer fluid 16 is supplied to the inlet opening 36 of the inlet-side body 108 and is then supplied to the communication opening 40 through the inlet passage 34 (including the fitting hole 38). When the fluid pressure of the washer fluid 16 becomes greater than the closing force applied to the valve body 84 of the valve arrangement 78 for closing the communication opening 40 (i.e., a sum of the urging force of the anchoring portion 80 and the connectors 82 of the valve arrangement 78 and the urging force of the compression coil spring 88), the connectors 82 and the anchoring portion 80 are stretched by the fluid pressure of the washer fluid 16, and the compression coil spring 88 is compressed. Thus, the valve body 84 is moved (lifted) away from the communication opening 40. As a result, the washer fluid 16 is supplied (pumped) from the communication opening 40 into the communication passage 116 of the outlet-side body 110 and is discharged from each outlet opening 126 through the communication passage 116 (including the flow passages 86 of the valve arrangement 78 and the retaining hole 118) and the corresponding outlet passage 124. In this way, the washer fluid 16 is supplied (pumped) to each washer nozzle 104 through the corresponding outlet-side hose 28 and is then discharged from each corresponding discharge opening 72 of the washer nozzle 104 to wash the windshield.

When the washer pump 18 is stopped, i.e., is in a non-operating state, the washer fluid 16 is not supplied to the inlet opening 36, so that the valve body 84 closes the communication opening 40. Thus, the flow of the washer fluid 16 from the communication opening 40 (fitting hole 38) to the communication passage 116 and the flow of the washer fluid 16 from the communication passage 116 to the communication opening 40 (the fitting hole 38) are limited. Therefore, in the non-operating state of the washer pump 18, even when the acceleration is applied to the washer fluid 16, which is contained in the inlet-side hose 20, the branched joint 100 and the outlet-side hoses 28, due to the vibrations and turning movement of the vehicle, the washer fluid 16 contained in, for example, the washer nozzle 104 does not leak from the washer nozzle 104. Furthermore, the washer fluid 16 can be kept filled in the inlet-side hose 20, the outlet-side hoses 28 and the washer nozzles 104. More specifically, the valve body 84 closes the communication opening 40, so that flow of air from the washer nozzle 104 into the outlet-side hoses 28, into the branched joint 100 and into the inlet-side hose 20 can be limited. As a result, when the washer pump 18 is driven to pump the washer fluid 16, the valve body 84 is immediately lifted. Therefore, the time required to initiate the discharge of washer fluid 16 from the outlet opening 126 of the branched joint 100 becomes short, so that discharge response (the time required to discharge the washer fluid 16 upon receiving a discharge command for discharging the washer fluid 16) can be improved. Furthermore, the time required to discharge the washer fluid 16 from the washer nozzle 104 is relative short, so that discharge response (the time required to discharge the washer fluid 16 upon receiving the discharge command for discharging the washer fluid 16) is improved.

Furthermore, the filter 44 provided in the fitting hole 38 of the inlet-side body 108 blocks the foreign particles contained in the washer fluid. Thus, the clogging of the discharge opening 72 of the washer nozzle 104 can be prevented.

In the above embodiment, the check valve unit 76 is provided in the communication passage 116 of the outlet-side body 110, and the filter 44 is provided in the fitting hole 38 of the inlet-side body 108. Thus, the filter 44 is arranged on the inlet opening 36 side (on the upstream side) of the check valve unit 76 (the valve arrangement 78) in the fluid passage 128. In this way, the operational movement of the check valve unit 76 is not interfered by the foreign particles contained in the washer fluid 16, and the sealing performance of the check valve unit 76 is not deteriorated by the foreign particles contained in the washer fluid 16. Therefore, it is possible to limit deterioration of the function of the check valve unit 76.

Furthermore, as described above, the inlet opening 36 is communicated with the outlet openings 126 through the filter 44 and the check valve unit 76. Thus, washer fluid 16, which is supplied from the inlet opening 36, passes through the filter 44 and the check valve unit 76 and is divided into two flows, which are, in turn, discharged from the outlet openings 126, respectively. Thus, the common filter 44 and the common check valve unit 76 can limit flow of the foreign particles, which are contained in the washer fluid 16, to the outlet openings 126 and can close the fluid passage 128. In this way, it is not required to provide separate filters and separate check valve units to the outlet openings 126, respectively. Thus, the structure of the branched joint 100 is simplified.

Furthermore, as described above, the joint body 106 is formed by assembling the inlet-side body 108, which includes the inlet opening 36, and the outlet-side body 110, which includes the outlet opening 126. Thus, the provision of the check valve unit 76 and the filter 44 in the joint body 106 is eased.

The inlet-side body 108 and the outlet-side body 110 are assembled together by the engagement of the engaging projections 114 to the engaging holes 54. At the time of this engagement, the anchoring portion 80 of the valve arrangement 78 is radially securely clamped between the upper part of the inlet-side body 108 and the lower part of the connecting portion 112 of the outlet-side body 110, and the O-ring section of the anchoring portion 80 is vertically securely clamped between the upper surface of the clamp plate 50 of the inlet-side body 108 and the lower surface of the connecting portion 112 and is radially and vertically clamped by the inlet-side body 108 and the outlet-side body 110 to seal therebetween. Thus, the valve arrangement 78 can be secured through the anchoring portion 80 without requiring joining of the inlet-side body 108 with the outlet-side body 110 by, for example, ultrasonic welding. Furthermore, sealing of the joint body 10 can be achieved by the anchoring portion 80. In this way, even after assembly of the inlet-side body 108 and the outlet-side body 110, the inlet-side body 108 and the outlet-side body 110 can be separated from one another by disengaging the engaging projections 114 from the engaging holes 54. Thus, maintenance work or adjustment work of the interior of the joint body 106 (e.g., the check valve unit 76 or the filter 44) can be performed. Furthermore, this structure allows replacement of a defective component of the branched joint 100 with an appropriate replacement component. Therefore, it is not required to replace the entire branched joint 100 with a new one, and it is only required to replace the defective component of the branched joint 100 with the appropriate replacement component, allowing recycling of the other components of the branched joint 100.

Furthermore, as discussed above, the anchoring portion 80 of the valve arrangement 78 seals the connection between the inlet-side body 108 and the outlet-side body 110, so that it is not required to provide a separate sealing component, which seals the connection between the inlet-side body 108 and the outlet-side body 110. The check valve unit 76 only includes the valve arrangement 78 and the compression coil spring 88. Thus, the number of components and the number of assembling steps can be reduced to minimize the manufacturing costs.

The compression coil spring 88 is arranged in the communication passage 116 of the outlet-side body 110 and urges the valve body 84 of the valve arrangement 78 toward the communication opening 40 (inlet opening 36 side). Thus, the valve body 84 can quickly close the communication opening 40 (the fluid passage 128) to improve closing response for closing the communication opening 40 by the valve body 84. Furthermore, the closed state of the communication opening 40 can be effectively maintained by the valve body 84 through use of the urging force of the compression coil spring 88.

Furthermore, the valve body 84 is engaged with the valve seat 48, which is provided around the communication opening 40. In this embodiment, the valve seat 48 projects toward the valve body 84 beyond the filter 44, so that the valve body 84 does not have surface contact with the filter 44 but has line contact with the valve seat 48. Thus, the contact pressure of the valve body 84 against to the valve seat 48 is advantageously increased, so that the valve body 84 can effectively close the communication opening 40.

The valve body 84 engages the valve seat 48, which is provided around the communication opening 40, while the anchoring portion 80 and the connectors 82 are stretched. Thus, the valve body 84 can be engaged with the valve seat 48 while the valve body 84 is pressed by the contracting force (urging force) of the anchoring portion 80 and the connectors 82. Furthermore, at the time of engaging the valve body 84 with the valve seat 48, the valve body 84 conforms to a shape of an upper end of the valve seat 48 (an outer peripheral shape of the communication opening 40) due to the elasticity of the valve body 84. In this way, the communication opening 40 can be effectively closed, and flow of the washer fluid 16 from the communication opening 40 into the communication passage 116 and flow of the washer fluid 16 from the communication passage 116 into the communication opening 40 can be effectively limited.

Furthermore, when the inlet-side body 108 and the outlet-side body 110 are assembled together, the engaging projections 114 of the outlet-side body 110 are engaged with the engaging holes 54 of the inlet-side body 108, and the resiliently deformed anchoring portion 80 (O-ring section) of the valve arrangement 78 is tightly clamped between the upper surface of the clamp plate 50 and the lower surface of the connecting portion 112. Thus, restoring force of the resiliently deformed anchoring portion 80 can maintain the state of the engagement between the engaging projections 114 and the engaging holes 54 (i.e., the engagement between the lateral surface of the engaging projection 114 and the upper surface of the engaging hole 54) without generating rattling vibrational noise. In this way, the engagement between the inlet-side body 108 and the outlet-side body 110 can be maintained without generating the rattling vibrational noise, so that inappropriate assembly of the inlet-side body 108 with the outlet-side body 110 can be avoided. Furthermore, the engagement between the engaging projections 114 and the engaging holes 54 can maintain the tight clamping of the resiliently deformed anchoring portion 80. Thus, the secured state of the valve arrangement 78 is maintained, and the sealing of the joint body 106 is maintained.

In the second embodiment, the check valve unit 76 includes the valve arrangement 78 and the compression coil spring 88. However, the compression coil spring 88 can be eliminated to construct the check valve unit only with the valve arrangement 78 if the required closing force for closing the communication opening 40 by the valve body 84 can be achieved only by the urging force of the anchoring portion 80 and the connectors 82 of the valve arrangement 78, i.e., if the flow of the washer fluid 16 from the communication opening 40 into the communication passage 116 and the flow of the washer fluid 16 from the communication passage 116 into the communication opening 40 can be effectively limited in the non-operating state of the washer pump 18. In such a case, the check valve unit only includes the valve arrangement. Thus, the number of components and the number of assembling steps can be further reduced, and thereby the manufacturing costs can be further reduced.

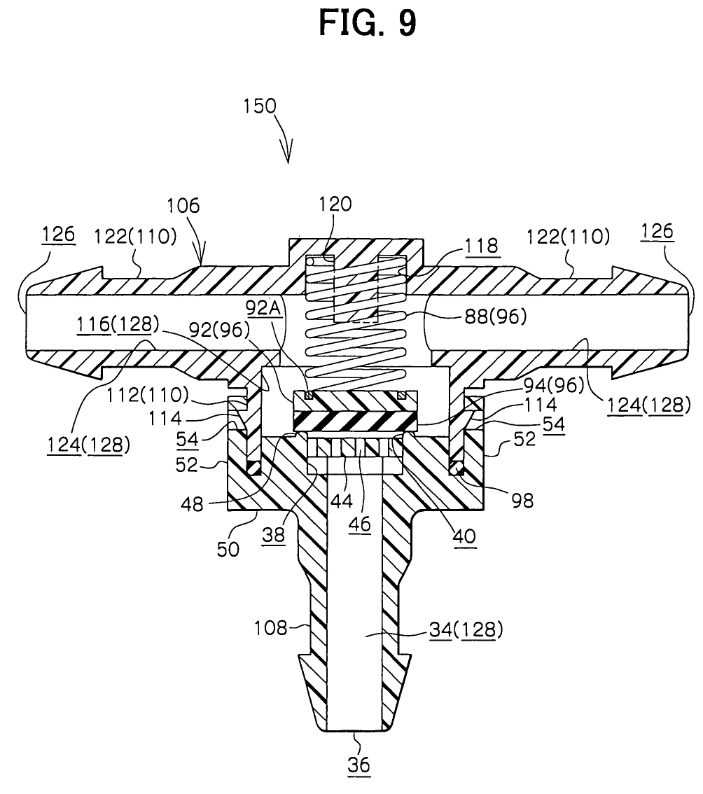

Furthermore, a check valve unit similar to the one shown in FIG. 9 can be used in place of the check valve unit 76 of the above embodiment, as in a case of a branched joint (hose joint) 150 shown in FIG. 9. In this case, an O-ring 98 similar to the one shown in FIG. 6 is resiliently deformed and is tightly clamped between the upper surface of the clamp plate 50 and the lower surface of the connecting portion 112. In this way, the joint body 106 is sealed.

Furthermore, in the second embodiment, the outlet portions 122 and the outlet openings 126 are provided in the outlet-side body 110 of the branched joint 100 (hose joint). Alternatively, only a single outlet portion and a single outlet opening can be provided in the outlet-side body of the hose joint.

Furthermore, in the second embodiment, the washer nozzle 104, which does not have the check valve unit 76 and the filter 44, is used. Alternatively, the washer nozzle 10 of the first embodiment, which includes the check valve unit 76 and the filter 44, can be used in place of the washer nozzle 104.

Furthermore, in the first and second embodiments, the filter 44 is formed integrally with the lower body 32 or the inlet-side body 108 in the corresponding fitting hole 38. Alternatively, the filter 44 can be formed separately from the lower body 32 or the inlet-side body 108 and can be press fitted in the corresponding fitting hole 38 as a filter plate.

Furthermore, in the washer nozzle 10 of the first embodiment, the lower body 32 and the upper body 56 are fitted together and are kept engaged by the engagement between the engaging holes 54 and the engaging projections 60. In addition, in the branched joint (hose joint) 100 of the second embodiment, the inlet-side body 108 and the outlet-side body 110 are fitted together and are kept engaged by the engagement between the engaging holes 54 and the engaging projections 114. However, the present invention is not limited to this. For example, the lower body and the upper body can be joined together by ultrasonic welding. Also, the inlet-side body and the outlet-side body can be joined together by ultrasonic welding.

Additional advantages and modifications will readily occur to those skilled in the art. The invention in its broader terms is therefore not limited to the specific details, representative apparatus, and illustrative examples shown and described.

What is claimed is:

1. A valve assembly for a washer system, the valve assembly comprising:
a housing that includes:
an inlet opening, from which washer fluid is inputted into the housing;
at least one outlet opening, from which the washer fluid is outputted from the housing; and
a fluid passage that communicates between the inlet opening and the at least one outlet opening;
a check valve that is arranged in the fluid passage of the housing, wherein the check valve permits forward flow of the washer fluid in a first direction from the inlet opening toward the at least one outlet opening and blocks backflow of the washer fluid in a second direction opposite from the first direction; and
a filter that is arranged in the fluid passage of the housing between the inlet opening and the check valve to filter the washer fluid.

2. The valve assembly according to claim 1, wherein the housing is a nozzle body of a washer nozzle of the washer system.

3. The valve assembly according to claim 2, wherein:
the nozzle body includes a first body part and a second body part, which are connected together;
the first body part includes the inlet opening and a first part of the fluid passage;
the second body part includes the at least one outlet opening and a second part of the fluid passage; and
each of the at least one outlet opening is a discharge opening that discharges the washer fluid.

4. The valve assembly according to claim 2, wherein:
the check valve is provided in the second body part; and
the filter is provided in the first body part.

5. The valve assembly according to claim 2, wherein:
the nozzle body includes a valve seat that is provided in the fluid passage and protrudes in a direction away from the filter toward the check valve;
the check valve is seated against the valve seat when the check valve blocks the backflow of the washer fluid in the second direction; and
the check valve is lifted away from the valve seat when the check valve permits the forward flow of the washer fluid in the first direction.

6. The valve assembly according to claim 3, wherein the check valve includes:
an anchoring portion that is formed into an annular shape and is securely clamped between the first body part and the second body part to seal a connection between the first body part and the second body part;
at least one connector that extends radially inward from the anchoring portion;
a valve body that is located radially inward of the anchoring portion and is connected to the at least one connector, wherein:
the valve body closes a communication opening, which is formed between the first part of the fluid passage and the second part of the fluid passage, when the check valve blocks the backflow of the washer fluid in the second direction; and
the valve body is pushed by the washer fluid and opens the communication opening when the check valve permits the forward flow of the washer fluid in the first direction; and
at least one flow passage that extends through the check valve, wherein each flow passage is radially positioned between the anchoring portion and the valve body.

7. The valve assembly according to claim 2, further comprising a spring that is provided in the fluid passage and urges the check valve toward the inlet opening.

8. The valve assembly according to claim 6, wherein:
the second body part includes at least one engaging portion; and
the first body part includes at least one engaging portion, which is engaged with the at least one engaging portion of the second body part to connect the second body part and the first body part together and thereby to resiliently deform and to clamp the anchoring portion between the second body part and the first body part.

9. The valve assembly according to claim 1, wherein the check valve is integrally made of a resilient material.

10. The valve assembly according to claim 1, wherein the filter is formed integrally with a portion of the housing.

11. The valve assembly according to claim 1, wherein:
the housing is a joint body of a branched joint of the washer system, wherein the branched joint connects between an inlet-side hose and at least one outlet-side hose of the washer system;
the inlet opening of the joint body is engaged with the inlet-side hose; and
the at least one outlet opening of the joint body is engaged with the at least one outlet-side hose.

12. The valve assembly according to claim 11, wherein:
the joint body includes a first body part and a second body part, which are connected together;
the first body part includes the inlet opening and a first part of the fluid passage; and
the second body part includes the at least one outlet opening and a second part of the fluid passage.

13. The valve assembly according to claim 12, wherein:
the check valve is provided in the second body part; and
the filter is provided in the first body part.

14. The valve assembly according to claim 11, wherein:
the at least one outlet opening of the joint body includes a plurality of outlet openings; and
the inlet opening of the joint body is communicated with each outlet opening through the filter and the check valve.

15. The valve assembly according to claim 12, wherein the check valve includes:
an anchoring portion that is formed into an annular shape and is securely clamped between the first body part and the second body part to seal a connection between the first body part and the second body part;
at least one connector that extends radially inward from the anchoring portion;
a valve body that is located radially inward of the anchoring portion and is connected to the at least one connector, wherein:
the valve body closes a communication opening, which is formed between the first part of the fluid passage and the second part of the fluid passage, when the check valve blocks the backflow of the washer fluid in the second direction; and
the valve body is pushed by the washer fluid and opens the communication opening when the check valve permits the forward flow of the washer fluid in the first direction; and
at least one flow passage that extends through the check valve, wherein each flow passage is radially positioned between the anchoring portion and the valve body.

16. The valve assembly according to claim 15, wherein:
the second body part includes at least one engaging portion; and
the first body part includes at least one engaging portion, which is engaged with the at least one engaging portion of the second body part to connect the second body part and the first body part together and thereby to resiliently deform and to clamp the anchoring portion between the second body part and the first body part.
